(19) United States
(12) Patent Application Publication
(10) Pub. No.: US 2021/0125075 A1
(43) Pub. Date: Apr. 29, 2021

(54) TRAINING ARTIFICIAL NEURAL NETWORK MODEL BASED ON GENERATIVE ADVERSARIAL NETWORK

(71) Applicant: LG ELECTRONICS INC., Seoul (KR)

(72) Inventor: Kwangyong LEE, Seoul (KR)

(21) Appl. No.: 17/029,256

(22) Filed: Sep. 23, 2020

(30) Foreign Application Priority Data
Oct. 24, 2019 (KR) 10-2019-0133142

(51) Int. Cl. G06N 3/08; G06K 9/62

(52) U.S. Cl. CPC G06N 3/084; G06K 9/6256; G06K 9/6234; G06K 9/6277; G06K 9/6215

(57) ABSTRACT

Provided is training an artificial neural network model based on a GAN. In a method of training a classification model based on a GAN, a classification model capable of deducing an inference result of unknown and/or rejection can be generated by differently generating and training in-domain data and out-of-domain data in time series using a generative model. An intelligent device according to the present disclosure may be associated with an artificial intelligence module, a drone (unmanned aerial vehicle (UAV)), a robot, an augmented reality (AR) device, a virtual reality (VR) device, and 5G service-related devices.

This application is based on and claims priority under 35 U.S.C. 119 to Korean Patent Application No. 10-2019-0133142, filed on Oct. 24, 2019, in the Korean Intellectual Property Office, the disclosure of which is herein incorporated by reference in its entirety.

### BACKGROUND OF THE INVENTION

### Field of the Invention

The present disclosure relates to training an artificial neural network model based on a generative adversarial network (GAN).

### Related Art

An artificial intelligence (AI) system is a computer system that achieve human-level intelligence, which, unlike existing rule-based smart systems, makes machines smart enough to learn and decide on their own. The more the artificial intelligence system is used, the higher its recognition rate and the better it understands a user's preferences. Hence, the existing rule-based smart systems are being gradually replaced by deep learning-based artificial intelligence systems.

Artificial intelligence technologies include machine learning and element technologies using machine learning.

Machine learning is an algorithm technology for autonomously classifying/learning features of input data. An element technology is a technology for simulating functions, such as the perception and decision of a human brain, using a machine learning algorithm such as deep learning, and is configured with technology fields, such as linguistic understanding, visual understanding, inference/prediction, knowledge representation, and operation control.

Various fields to which the artificial intelligence technology is applied are as follows. Linguistic understanding is a technology for recognizing a human language/character and applying/processing the human language/character, and includes natural language processing, machine translation, a dialogue system, question and answer, and voice recognition/synthesis. Visual understanding is a technology for processing a thing by recognizing the thing like a human sight, and includes object recognition, object tracking, image search, person recognition, scene understanding, space understanding, and image improvement. Inference prediction is a technology for determining, logically inferring, and predicting information, and includes knowledge/probability-based inference, optimization prediction, a preference-based plan, and recommendations. Knowledge representation is a technology for automating and processing human experience information as knowledge data, and includes a knowledge construction (e.g., data generation/classification) and knowledge management (e.g., data usage). Operation control is a technology for controlling autonomous driving of a vehicle and a motion of a robot, and includes motion control (e.g., navigation, a collision and traveling) and manipulation control (e.g., behavior control).

A classification model, that is, an example of the deep learning model, has a problem in that it deduces an erroneous determination result without deducing a determination result of unknown or rejection with respect to given input data having small relevance with pre-learnt training data in performing AI processing related to the input data.

### SUMMARY

The present disclosure is to solve the aforementioned need and/or problem.

Furthermore, the present disclosure is to implement the training of an artificial neural network model based on a GAN, which can generate simulated data close to reality and improve classification performance of a classification model using the simulated data.

Furthermore, the present disclosure is to implement the training of an artificial neural network model based on a GAN capable of deducing a determination result of unknown with respect to pre-learnt data and data other than data associated with pre-learnt data.

In an aspect, a method of training a classification model based on a generative adversarial network (GAN) includes receiving real data, receiving first simulated data generated by a generative model during a first period and training a GAN model using the first simulated data and the real data during the first period, receiving second simulated data generated by the generative model during a second period after a lapse of the first period, and training the GAN model using the second simulated data and the real data during the second period. The GAN model may include the generative model for generating the first and second simulated data and a classification model for discriminating between the real data and the first and second simulated data.

Furthermore, the real data may be training data provided by a user.

Furthermore, the second simulated data may have a higher similarity with the real data than the first simulated data.

Furthermore, the similarity may be similarity based on an angle between a vector corresponding to the first or second simulated data and a vector of the real data.

Furthermore, the similarity may be determined by comparing probability distributions of the first or second simulated data and the real data using a Kullback Leibler term (KL term).

Furthermore, the length of the first period and the second period may be ½ times a total training period.

Furthermore, a label value of all nodes included in the output layer of the classification model during the first period may be 1/N (N is the number of all the nodes included in the output layer).

Furthermore, a label of all nodes included in the output layer of the classification model during the second period may be stored as a one-hot vector.

Furthermore, the GAN model outputs unknown when all nodes included in the output layer of the classification model are deactivated.

Furthermore, the GAN model may be trained in a backward propagation manner.

Furthermore, the classification model includes a first classification model for discriminating between the first or second simulated data and the real data and a second classification model for discriminating between one or more discrimination targets by comparing scores or probability distributions corresponding to classes of the one or more discrimination target, respectively.

Furthermore, training the GAN model during the first period may include determining a first error for the first simulated data by inputting, to the first classification model, the first simulated data generated by the generative model, determining a second error for the first simulated data by inputting the first simulated data to the second classification model, and training at least one of the generative model or the first and second classification models using the first and second errors.

Furthermore, training the GAN model during the second period may include determining a third error for the first simulated data by inputting, to the first classification model, the second simulated data generated by the generative model, determining a fourth error for the first simulated data by inputting the second simulated data to the second classification model, and training at least one of the generative model or the first and second classification models using the third and fourth errors.

In another embodiment, an intelligent device includes a communication module configured to receive real data, and a processor configured to receive first simulated data generated by a generative model during a first period, train a GAN model using the first simulated data and the real data during the first period, receive second simulated data generated by the generative model during a second period after a lapse of the first period, and train the GAN model using the second simulated data and the real data during the second period. The GAN model may include the generative model for generating the first and second simulated data and a classification model for discriminating between the real data and the first and second simulated data.

Effects of the training of the artificial neural network model based on a GAN according to an embodiment of the present disclosure are as follows.

The present disclosure can generate simulated data close to reality and enhance classification performance of a classification model using the simulated data.

Furthermore, the present disclosure can deduce a determination result of unknown for pre-learnt data and data other than data associated with the pre-learnt data.

Effects which may be obtained in the present disclosure are not limited to the aforementioned effects, and other technical effects not described above may be evidently understood by a person having ordinary skill in the art to which the present disclosure pertains from the following description.

### BRIEF DESCRIPTION OF THE DRAWINGS

The accompany drawings, which are included as part of the detailed description in order to help understanding of the present disclosure, provide embodiments of the present disclosure and describe the technical characteristics of the present disclosure along with the detailed description.

FIG. 1 illustrates a block diagram of a wireless communication system to which the methods proposed in the present disclosure may be applied.

FIG. 2 illustrates an example of a signal transmission/reception method in a wireless communication system.

FIG. 3 illustrates an example of a basic operation of a user equipment and a 5G network in a 5G communication system.

FIG. 4 is a block diagram of an AI device in accordance with the embodiment of the present disclosure.

FIG. 5 is a block diagram for describing a GAN model.

FIGS. 6 to 8 are diagrams for describing a method of training an artificial neural network model according to a first embodiment of the present disclosure.

FIG. 9 is a flowchart of a method of training an artificial neural network model according to a first embodiment of the present disclosure.

FIG. 10 is a flowchart for describing S110 illustrated in FIG. 9.

FIG. 11 is a flowchart for describing S120 illustrated in FIG. 9.

FIG. 12 is a diagram for describing a method of training an artificial neural network model according to a second embodiment of the present disclosure.

FIG. 13 is a flowchart of a method of training an artificial neural network model according to a second embodiment of the present disclosure.

FIG. 14 is one implementation example of data classification using a trained artificial neural network model according to an embodiment of the present disclosure.

FIG. 15 is a flowchart of the one implementation example illustrated in FIG. 14.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

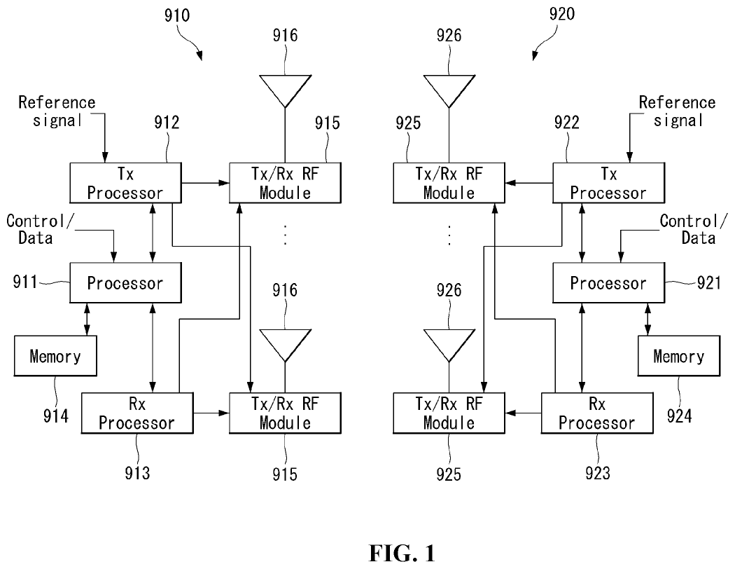

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

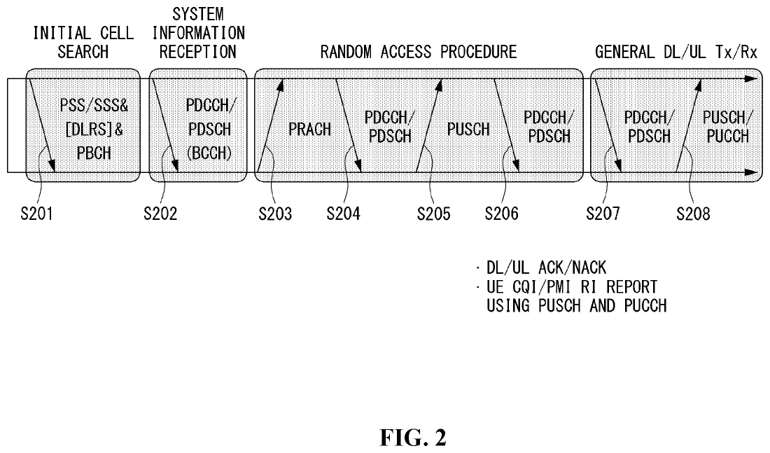

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group.

The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between User Equipments Using 5G Communication

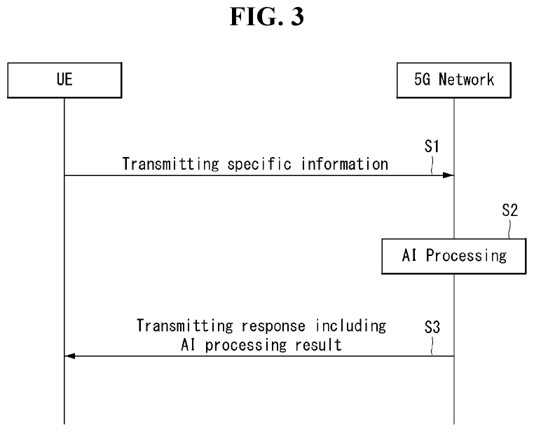

FIG. 3 shows an example of basic operations of a user equipment and a 5G network in a 5G communication system.

The user equipment transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the user equipment (S3).

G. Applied Operations Between User Equipment and 5G Network in 5G Communication System

Hereinafter, the operation of a user equipment using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the user equipment performs an initial access procedure and a random access procedure with the 5G network prior to step S1 of FIG. 3 in order to transmit/receive signals, information and the like to/from the 5G network.

More specifically, the user equipment performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the user equipment receives a signal from the 5G network.

In addition, the user equipment performs a random access procedure with the 5G network for UL synchronization acquisition and/or UL transmission. The 5G network can transmit, to the user equipment, a UL grant for scheduling transmission of specific information. Accordingly, the user equipment transmits the specific information to the 5G network on the basis of the UL grant. In addition, the 5G network transmits, to the user equipment, a DL grant for scheduling transmission of 5G processing results with respect to the specific information. Accordingly, the 5G network can transmit, to the user equipment, information (or a signal) related to remote control on the basis of the DL grant.

Next, a basic procedure of an applied operation to which a method proposed by the present invention which will be described later and URLLC of 5G communication are applied will be described.

As described above, a user equipment can receive DownlinkPreemption IE from the 5G network after the user equipment performs an initial access procedure and/or a random access procedure with the 5G network. Then, the user equipment receives DCI format 2_1 including a preemption indication from the 5G network on the basis of DownlinkPreemption IE. The user equipment does not perform (or expect or assume) reception of eMBB data in resources (PRBs and/or OFDM symbols) indicated by the preemption indication. Thereafter, when the user equipment needs to transmit specific information, the user equipment can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the user equipment receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the user equipment transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

AI Device

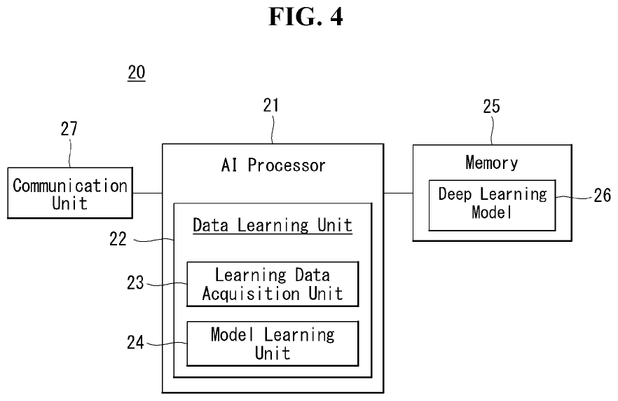

FIG. 4 is a block diagram of an AI device in accordance with the embodiment of the present disclosure.

The AI device 20 may include electronic equipment that includes an AI module to perform AI processing or a server that includes the AI module.

The AI device 20 may include an AI processor 21, a memory 25 and/or a communication unit 27.

The AI device 20 may be a computing device capable of learning a neural network, and may be implemented as various electronic devices such as a server, a desktop PC, a laptop PC or a tablet PC.

The AI processor 21 may learn the neural network using a program stored in the memory 25. Particularly, the AI processor 21 may learn the neural network for recognizing data related to the intelligent refrigerator 100. Here, the neural network for recognizing data related to the intelligent refrigerator 100 may be designed to simulate a human brain structure on the computer, and may include a plurality of network nodes having weights that simulate the neurons of the human neural network. The plurality of network nodes may exchange data according to the connecting relationship to simulate the synaptic action of neurons in which the neurons exchange signals through synapses. Here, the neural network may include the deep learning model developed from the neural network model. While the plurality of network nodes is located at different layers in the deep learning model, the nodes may exchange data according to the convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM,), a deep belief network (DBN) or a deep Q-Network, and may be applied to fields such as computer vision, voice recognition, natural language processing, voice/signal processing or the like.

Meanwhile, the processor performing the above-described function may be a general-purpose processor (e.g. CPU), but may be an AI dedicated processor (e.g. GPU) for artificial intelligence learning.

The memory 25 may store various programs and data required to operate the AI device 20. The memory 25 may be implemented as a non-volatile memory, a volatile memory, a flash memory), a hard disk drive (HDD) or a solid state drive (SDD). The memory 25 may be accessed by the AI processor 21, and reading/writing/correcting/deleting/update of data by the AI processor 21 may be performed.

Furthermore, the memory 25 may store the neural network model (e.g. the deep learning model 26) generated through a learning algorithm for classifying/recognizing data in accordance with the embodiment of the present disclosure.

The AI processor 21 may include a data learning unit 22 which learns the neural network for data classification/recognition. The data learning unit 22 may learn a criterion about what learning data is used to determine the data classification/recognition and about how to classify and recognize data using the learning data. The data learning unit 22 may learn the deep learning model by acquiring the learning data that is used for learning and applying the acquired learning data to the deep learning model.

The data learning unit 22 may be made in the form of at least one hardware chip and may be mounted on the AI device 20. For example, the data learning unit 22 may be made in the form of a dedicated hardware chip for the artificial intelligence AI, and may be made as a portion of the general-purpose processor (CPU) or the graphic dedicated processor (GPU) to be mounted on the AI device 20. Furthermore, the data learning unit 22 may be implemented as a software module. When the data learning unit is implemented as the software module (or a program module including instructions), the software module may be stored in a non-transitory computer readable medium. In this case, at least one software module may be provided by an operating system (OS) or an application.

The data learning unit 22 may include the learning-data acquisition unit 23 and the model learning unit 24.

The learning-data acquisition unit 23 may acquire the learning data needed for the neural network model for classifying and recognizing the data. For example, the learning-data acquisition unit 23 may acquire vehicle data and/or sample data which are to be inputted into the neural network model, as the learning data.

The model learning unit 24 may learn to have a determination criterion about how the neural network model classifies predetermined data, using the acquired learning data. The model learning unit 24 may learn the neural network model, through supervised learning using at least some of the learning data as the determination criterion. Alternatively, the model learning unit 24 may learn the neural network model through unsupervised learning that finds the determination criterion, by learning by itself using the learning data without supervision. Furthermore, the model learning unit 24 may learn the neural network model through reinforcement learning using feedback on whether the result of situation determination according to the learning is correct. Furthermore, the model learning unit 24 may learn the neural network model using the learning algorithm including error back-propagation or gradient descent.

If the neural network model is learned, the model learning unit 24 may store the learned neural network model in the memory. The model learning unit 24 may store the learned neural network model in the memory of the server connected to the AI device 20 with a wire or wireless network.

The data learning unit 22 may further include a learning-data preprocessing unit (not shown) and a learning-data selection unit (not shown) to improve the analysis result of the recognition model or to save resources or time required for generating the recognition model.

The learning-data preprocessing unit may preprocess the acquired data so that the acquired data may be used for learning for situation determination. For example, the learning-data preprocessing unit may process the acquired data in a preset format so that the model learning unit 24 may use the acquired learning data for learning for image recognition.

Furthermore, the learning-data selection unit may select the data required for learning among the learning data acquired by the learning-data acquisition unit 23 or the learning data preprocessed in the preprocessing unit. The selected learning data may be provided to the model learning unit 24. For example, the learning-data selection unit may select only data on the object included in a specific region as the learning data, by detecting the specific region in the image acquired by the camera of the intelligent refrigerator 100.

Furthermore, the data learning unit 22 may further include a model evaluation unit (not shown) to improve the analysis result of the neural network model.

When the model evaluation unit inputs evaluated data into the neural network model and the analysis result outputted from the evaluated data does not satisfy a predetermined criterion, the model learning unit 22 may learn again. In this case, the evaluated data may be predefined data for evaluating the recognition model. By way of example, the model evaluation unit may evaluate that the predetermined criterion is not satisfied when the number or ratio of the evaluated data in which the analysis result is inaccurate among the analysis result of the learned recognition model for the evaluated data exceeds a preset threshold.

The communication unit 27 may transmit the AI processing result by the AI processor 21 to the external electronic equipment.

Although the AI device 20 illustrated in FIG. 4 is functionally divided into the AI processor 21, the memory 25, the communication unit 27 and the like, it is to be noted that the above-described components are integrated into one module, which is referred to as an AI module.

Hereinafter, in this disclosure, a method of training an artificial neural network model included in the AI apparatus of FIG. 4 is described. Particularly, a method of training a deep learning model based on a generative adversarial network (GAN) is described in detail.

Generative Adversarial Network (GAN)

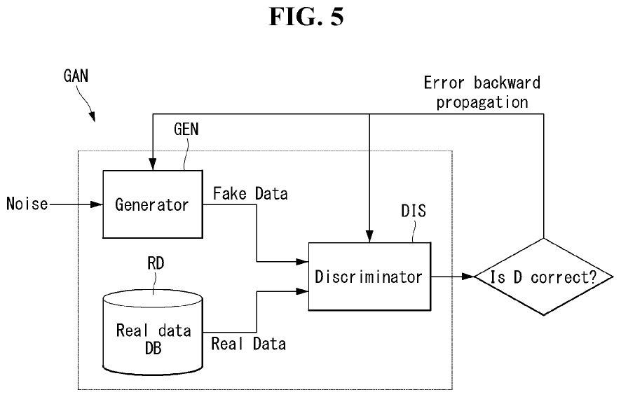

FIG. 5 is a block diagram for describing a GAN model.

Referring to FIG. 5, the GAN model may include a generative model (GEN), a discriminative model (DIS), and a database (DB). In this case, the elements illustrated in FIG. 5 are functional elements that are functionally divided. It is to be noted that at least one element may be implemented in an integrated form in an actual physical environment.

A “generative model (GEN)” and a “generator” may be interchangeably used. A “discriminative model (DIS)” and a “discriminator” may be interchangeably used. A “classifier” and a “classification model” may be interchangeably used.

The generative model (GEN) may generate simulated data. In this case, the simulated data may include first simulated data and second simulated data. The first simulated data denotes simulated data initially generated in a process of training an artificial neural network model based on a GAN. The second simulated data denotes simulated data subsequently generated in a process of training an artificial neural network model based on a GAN.

The generative model (GEN) receives real data, and may generate simulated data by simulating the real data. That is, the simulated data is not actually collected data, but is data generated by a deep learning model. The generative model (GEN) receives random noise, and may generate simulated data using the received random noise.

The process of training the artificial neural network model based on a GAN may include a first period and a second period. In this case, the first period denotes a period in which simulated data generated from the generative model (GEN) included in the GAN model is applied to the discriminative model (DIS) and real data is selected with a probability of less than a preset critical value as a result of the application. The second period denotes a period in which simulated data generated from the generative model (GEN) included in the GAN model is applied to the discriminative model (DIS) and real data is selected with a probability of a preset critical value as a result of the application. In this case, the critical value may be 50% (or 0.5), but is not limited thereto.

The first simulated data may be data generated by the generative model (GEN) during the first period. The second simulated data may be data generated by the generative model (GEN) during the second period. The first and second simulated data are merely classified as ordinal numbers based on a period in which data is generated, and at least one simulated data included in the first or second simulated data is not construed as having the same data. For example, as training is performed on the artificial neural network model based on a GAN, a weight and/or bias for at least one node included in the generative model (GEN) and the discriminative model (DIS) may vary. As the weight and/or the bias varies, at least one simulated data included in the first or second simulated data may have different data.

The discriminative model (DIS) may discriminate whether input data is real data or simulated data. A processor may determine an error by comparing an output value of the discriminative model (DIS) with data labeled to the input data. The processor may train an artificial neural network model using the determined error in an error backward propagation manner.

The database may have stored real data. The real data stored in the database may have been previously stored by a user. Furthermore, the real data may be data received from a server.

The generative model (GEN) included in the GAN has an object of generating simulated data close to reality in order to cheat the discriminative model (DIS). The discriminative model (DIS) has an object of discriminating simulated data close to reality and real data. As described above, the generative model (GEN) and the discriminative model (DIS) perform different functions, and perform training so that their functions are enhanced. This is called hostile training.

Hereinafter, in this disclosure, hostile training is described in detail.

If hostile training is performed between the generative model (GEN) and the discriminative model (DIS), after training for the discriminative model (DIS) is sufficiently performed in initial training, training for the generative model (GEN) may be performed. The generative model (GEN) may be trained by backward propagating an error of the discriminative model (DIS) determined through an error determination process. If an error calculated in an inaccurate determination process is backward propagated initial training, the training of the generative model (GEN) may be adversely affected. Accordingly, in initial training, training may be performed based on the discriminative model (DIS). For example, when training is alternately performed, the training of the discriminative model (DIS) may be repeatedly performed by a designated number or more, and the training of the generative model (GEN) may be performed by less than the designated number.

In general, the input variable of a deep learning model based on a GAN is a variable having continuous data. Accordingly, in order to effectively train the deep learning model, a process of converting a category type variable into a continuous variable may be necessary. For example, the category type variable may be converted into a dummy variable having continuous data.

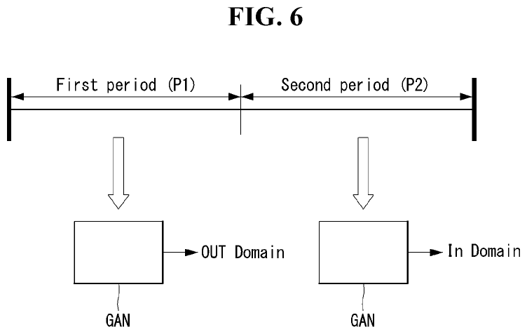

FIGS. 6 to 8 are diagrams for describing a method of training an artificial neural network model according to a first embodiment of the present disclosure.

Referring to FIG. 6, a process of training an artificial neural network model used in an embodiment of the present disclosure may include a first period and a second period. As described above with reference to FIG. 5, the first period denotes a period in which simulated data generated from the generative model (GEN) included in the GAN model is applied to the discriminative model (DIS) and real data is selected with a probability of less than a preset critical value as a result of the application. The second period denotes a period in which simulated data generated from the generative model (GEN) included in the GAN model is applied to the discriminative model (DIS) and real data is selected with a probability of a preset critical value or more as a result of the application. In this case, the critical value may be 50% (0.5), but is not limited thereto.

In an embodiment of the present disclosure, cost functions applied to the first period and the second period may be different. A first cost function may be used in the first period.

A second cost function may be used in the second period.

The first and second cost functions are described below.

[symbol]

_{P}_{ᵢₙ}_{(\hat{x},ŷ)}[−log P₀(y=ŷ|\hat{x})] (1)

In Equation 1, \hat{x} means a value applied to real data. ŷ means an output value output by the discriminative model (DIS) if real data is applied to the discriminative model (DIS). θ denotes a weight. Equation 1 is a known cost function used in a classification model, and is an equation for modifying a plurality of parameters of the classification model based on a difference between a label value and an inference value.

[symbol]

_{P}_{ᵢₙ}_{(\hat{x})}[log D(\hat{x})]+ [symbol] _{P}_{_{G}}₍ₓ₎[log(1−D(x))] (2)

D(\hat{x}) indicates a probability that real data may be inferred if the real data is applied) to the discriminative model (DIS). D(x) indicates a probability that simulated data will be inferred as real data if the simulated data is applied to the discriminative model (DIS). Equation 2 denotes a cost function commonly used in a GAN model.

[symbol]

_{P}_{_{G}}₍ₓ₎[KL [symbol] (y)∥P₀(y|x))] (3)

In Equation 3, KL indicates a value indicating how much is a difference between distributions of two data in a multi-dimensional probability distribution as Kullback Leibler Divergence. U(y) is a function that makes equal the probability distributions of all labels. U(y) may denote a uniform distribution function. A classification model may be trained to output an inference result of “UNKNOWN” with respect to training data input during the first period using Equation 3.

[symbol]

_{P}_{_{G}}₍ₓ₎[KL(1(y)∥P₀(y|x))] (4)

In Equation 4, KL denotes Kullback Leibler Divergence. 1 (y) is a function that enables a specific label to have a probability distribution of 1 and the remaining labels to have a probability distribution of 0. 1 (y) may denote a 1's distribution function. A classification model may be trained to output an inference result of “KNOWN” with respect to training data input during the second period using Equation 4.

$${min}_{G} {max}_{D} {min}_{θ} \underbrace{ {𝔼}_{{P}_{i n} ( \hat{x} , \hat{y} )} [ - log {P}_{θ} ( y = \hat{y} \vert \hat{x} ) ]}_{( c )} + β \underbrace{{𝔼}_{{P}_{G} ( x )} [ KL ( 𝒰 ( y ) \vert \vert {P}_{θ} ( y \vert x ) ) ]}_{( d )} + \underbrace{{𝔼}_{{P}_{i n} ( \hat{x} )} [ log D ( \hat{x} ) ] + {𝔼}_{{P}_{G} ( x )} [ log ( 1 - D ( x ) ) ] .}_{( e )} \qquad ( 5 )$$

Equation 5 is an equation in which Equations 1 to 3 have been combined. β is a parameter preset by a user, and is a parameter that controls an application level of Equation 3. In the present disclosure, Equation 5 is defined as the first cost function.

$${min}_{G} {max}_{D} {min}_{θ} \underbrace{{𝔼}_{{P}_{i n} ( \hat{x} , \hat{y} )} [ - log {P}_{θ} ( y = \hat{y} \vert \hat{x} ) ]}_{( c )} + β \underbrace{{𝔼}_{{P}_{G} ( x )} [ KL ( 1 ( y ) \vert \vert {P}_{θ} ( y \vert x ) ) ]}_{( d )} + \underbrace{{𝔼}_{{P}_{i n} ( \hat{x} )} [ log D ( \hat{x} ) ] + {𝔼}_{{P}_{G} ( x )} [ log ( 1 - D ( x ) ) ] .}_{( e )} \qquad ( 6 )$$

Equation 5 is an equation in which Equations 1, 2 and 4 have been combined. β is a parameter preset by a user, and is a parameter that controls an application level of Equation 4. In the present disclosure, Equation 5 is defined as the second cost function.

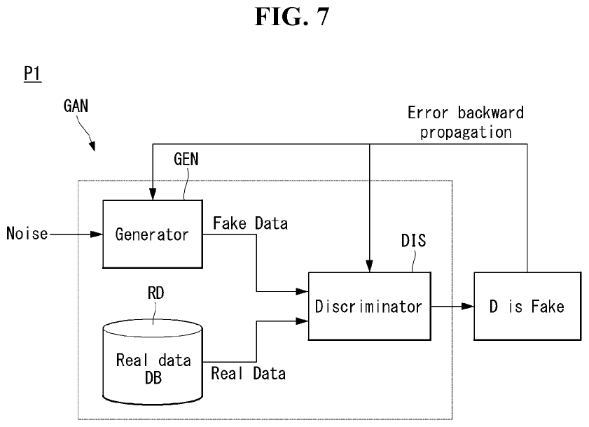

Referring to FIG. 7, during the first period, the processor may discriminate, as “Fake”, simulated data generated through the generative model. First simulated data generated during the first period is not similar to real data, and may be handled as out-of-domain (OD). A processor may train a classification model based on a GAN using the first cost function during the first period.

In this case, the classification model based on a GAN may learn even the first simulated data generated through the generative model in addition to pre-learnt data because the discrimination model learns a plurality of the first simulated data as OD data. As described above, the trained classification model based on a GAN may generate an inference result of “UNKNOWN” with respect to OD data in addition to real data.

When the inference result of “UNKOWN” is output, a plurality of nodes (or neurons) included in the output layer of the classification model is deactivated. Whether each of the plurality of nodes included in the output layer will be activated and/or deactivated may be determined using an activation function. In this case, if a value less than a classification critical value of the activation function is applied to a node of the output layer, the node of the output layer is deactivated. If all the nodes of the output layer are deactivated, the classification model may generate an output value corresponding to an inference result of “UNKNOWN.”

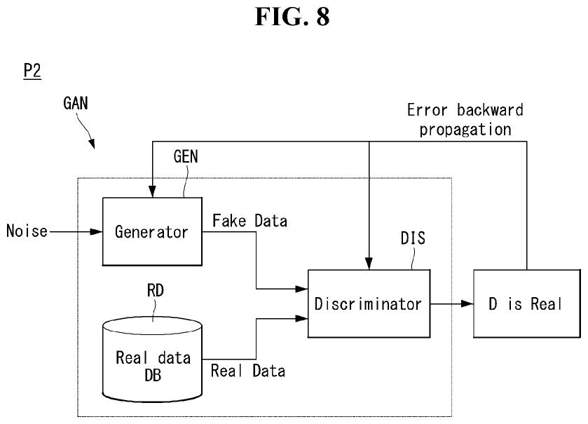

Referring to FIG. 8, during the second period, a processor may discriminate, as “Real”, simulated data generated through the generative model. The second simulated data generated during the second period may be handled as in-domain (ID) data because it is similar to real data. The processor may train a classification model based on a GAN using the second cost function during the second period.

In this case, the classification model based on a GAN learns a plurality of second simulated data as ID data, and thus may learn even the second simulated data generated through the generative model in addition to pre-learnt data. The classification model based on a GAN trained as described above may generate an inference result of “KNOWN” with respect to the ID data other than real data. Furthermore, the trained classification model based on a GAN may predict a classification result for at least one class unlike in OD data with respect to the ID data.

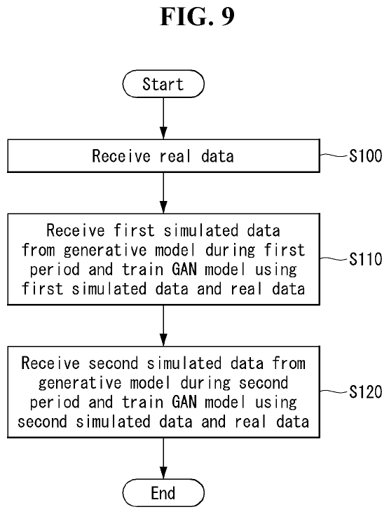

FIG. 9 is a flowchart of a method of training an artificial neural network model according to a first embodiment of the present disclosure.

Referring to FIG. 9, the AI apparatus 20 may receive real data (S100). The real data may be received from a server or may have been previously stored in an AI chip. The real data may be configured with a dataset, including input data and the label of the input data. That is, the real data defines training data or training dataset provided by a user.

The AI apparatus 20 may receive first simulated data from a generative model during a first period, and may train a classification model and/or generative model based on a GAN using the received first simulated data and the real data (S110). The simulated data generated through the generative model during the first period may have a low similarity with the real data. For example, the similarity may be determined through a Kullback Leibler Term (KL Term). A value of the KL Term may be determined based on a result of a comparison between probability distributions of two data. The AI apparatus 20 may compare probability distributions of the first simulated data and the real data, and may determine a cost value based on a similarity. For example, the similarity may be determined based on an angle between a feature vector, corresponding to the first simulated data, and the feature vector of the real data.

In a method of training a classification model based on a GAN according to an embodiment of the present disclosure, a label value of all nodes included in the output layer of the classification model during the first period may be 1/N (N is the number of all nodes included in the output layer). As described above, the AI apparatus 20 may compute the weight of the classification model so that all the nodes are deactivated by training the classification model so that a uniform label value is applied to all the nodes during the first period.

As described above, the AI apparatus 20 may output “UNKNOWN” when all nodes included in the output layer of the classification model based on a GAN are deactivated.

The AI apparatus 20 may receive second simulated data generated from the generative model during a second period, and may train the classification model and/or generative model based on a GAN using the received second simulated data and the real data (S120).

The second simulated data is simulated data generated through the generative model during the second period after the first period elapses. The second simulated data may have a high similarity with the real data. The second simulated data may have a higher similarity with the real data than the first simulated data.

For example, the similarity may be determined based on a Kullback Leibler Term (KL Term). The AI apparatus 20 may compare probability distributions of the first simulated data and the real data, and may determine a cost value based on a similarity. For example, the similarity may be determined based on an angle between a feature vector, corresponding to the first simulated data, and the feature vector of the real data.

In the method of training a classification model based on a GAN according to an embodiment of the present disclosure, the length of the first period and the second period may be ½ times a total training period. That is, the training times of the first period and the second period may be identically set. A phenomenon in which data is irregularly distributed to a specific domain can be prevented because the training periods are identically set and in-domain data and out-of-domain data maintain the same ratio.

In the method of training a classification model based on a GAN according to an embodiment of the present disclosure, a label value of all nodes included in the output layer of the classification model during the second period may be set in a one-hot-vector form. As described above, the AI apparatus 20 may control data, input received in an inference step, to be output as any one of a plurality of classes by setting a vector value, corresponding to any one of the plurality of classes, to 1 and setting the vector value of the other class to 0 and training the classification model.

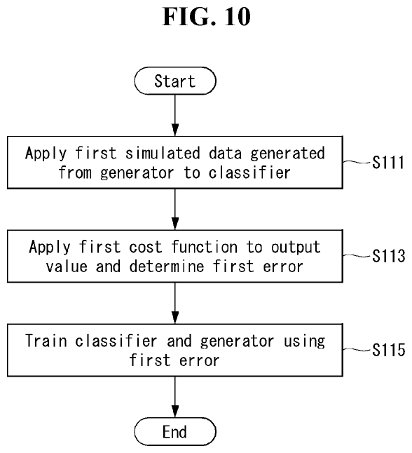

FIG. 10 is a flowchart for describing S110 illustrated in FIG. 9.

Referring to FIG. 10, the AI apparatus 20 may be applied to first simulated data generated from a generative model (S111). As described above, the first simulated data denotes data having a low similarity with real data, and may be denoted as out-of-domain (OD) data.

The AI apparatus 20 may determine a first error by applying a first cost function to an output value (S113).

The AI apparatus 20 may train a classification model and/or a generative model using the first error (S115).

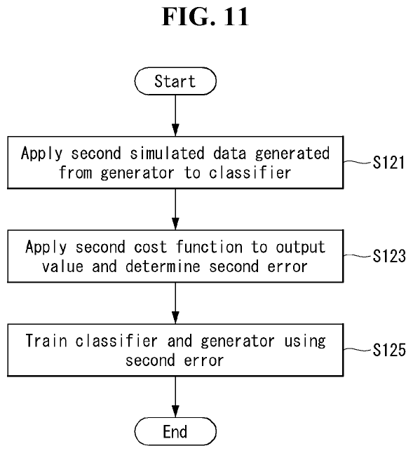

FIG. 11 is a flowchart for describing S120 illustrated in FIG. 9.

Referring to FIG. 11, the AI apparatus 20 may apply, to a classification model, second simulated data generated from a generative model (S121). As described above, the second simulated data denotes data having a high similarity with real data, and may be denoted as in-domain (ID) data. The second simulated data may have a higher similarity with the real data than the first simulated data.

The AI apparatus 20 may determine a second error by applying a second cost function to an output value (S123).

The AI apparatus 20 may train a classification model and/or a generative model using the second error (S125).

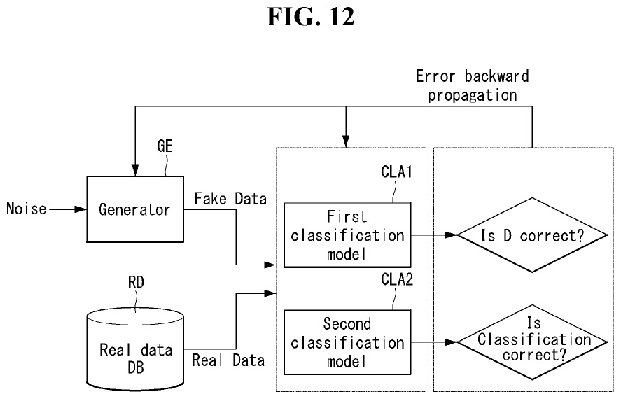

FIG. 12 is a diagram for describing a method of training an artificial neural network model according to a second embodiment of the present disclosure. Hereinafter, in this disclosure, a description of contents that are the same or similar to those of the aforementioned embodiment is omitted, and a difference between the second embodiment and the aforementioned embodiment is chiefly described.

Referring to FIG. 12, the discriminative model (DIS) of a classification model based on a GAN may include a first classification model CLA1 and a second classification model CLA2. The discriminative model (DIS) may further include one classification model compared to the discriminative model (DIS) illustrated in FIG. 5. The first classification model CLA1 and the second classification model CLA2 indicate elements that are functionally divided, and may be implemented as a single neural network depending on an implementation method.

The first classification model CLA1 may predict whether input data is real data like the discriminative model (DIS) illustrated in FIG. 5. The second classification model CLA2 may predict the class of input data from the input data. For example, when an image of a gorilla is input, a processor may determine whether the input image is real data using the first classification model CLA1, and may determine whether an object included in the input image is a gorilla using the second classification model CLA2.

A generative model may generate simulated data using random noise. The generative model may further apply data related to the class of real data in addition to the random noise, and may generate simulated data on which information on the class has been labeled. The classification model provides two types of discrimination results, and thus the generative model may be trained through an error determination process for the two types of discrimination results. Hereinafter, a method of training a classification model based on a GAN is additionally described with reference to FIG. 12.

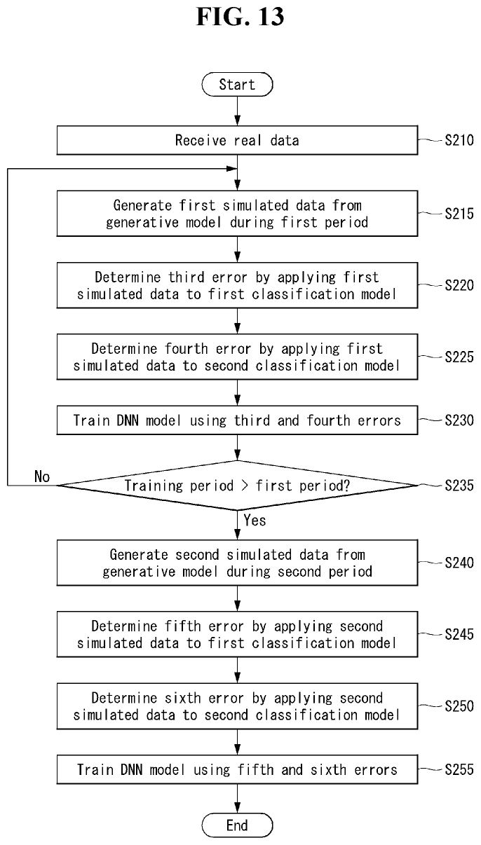

FIG. 13 is a flowchart of a method of training an artificial neural network model according to a second embodiment of the present disclosure.

The AI apparatus 20 may receive real data, and may generate first simulated data using a generative model during a first period (S210 and S215). In this case, the first simulated data may be classified as OD data.

The AI apparatus 20 may determine a third error by applying the first simulated data to a first classification model (S220). The third error may be used to optimize the ability to discriminate between the real data and simulated data of a classification model. For example, the third error may be used to optimize the ability to discriminate ID data and OD data.

As described above, the simulated data generated during the first period is handled as OD data, and simulated data generated during a second period is handled as ID data. Accordingly, the AI apparatus 20 may optimize a weight through an error backward propagation in order to increase the accuracy of classification when the ID data and the OD data are classified using the third error.

The AI apparatus 20 may determine a fourth error by applying the first simulated data to a second classification model (S225). For example, the AI apparatus 20 may optimize a weight through an error backward propagation in order to improve a classification function using the fourth error.

The AI apparatus 20 may train a deep learning model using the third and fourth errors (S235).

If a training time exceeds the first period (YES in S235), the AI apparatus 20 may generate second simulated data using a generative model during a second period (S240). In this case, the second simulated data may be classified as ID data.

The AI apparatus 20 may determine a fifth error by applying the second simulated data to the first classification model (S245). For example, the fifth error may be used to optimize the ability to discriminate between ID data and OD data.

As described above, the simulated data generated during the second period is handled as ID data. Accordingly, the AI apparatus 20 may optimize a weight through an error backward propagation in order to improve a function for discriminating between ID data and OD data using the fifth error.

The AI apparatus 20 may determine a sixth error by applying the second simulated data to the second classification model (S250). For example, the sixth error may be used to optimize a function for accurately discriminating the class of input data. The AI apparatus 20 may optimize a weight through an error backward propagation in order to improve a classification function using the sixth error.

The AI apparatus 20 may train a deep learning model using the fifth and sixth errors (S255). In this case, the processor may update the weights of the generative model and classification model by backward propagating the error backward propagations using the fifth and sixth errors. In this case, the weight of any one of the generative model or classification model of the discrimination model may not be updated.

Steps S210 to S255 may be repeatedly performed. That is, the training of the discriminative model (DIS) and the training of the generative model may be alternately performed.

If the classification model applied to an embodiment of the present disclosure is used, all the nodes of an output layer are deactivated if OD data is applied to the classification model. A processor may output “UNKNOWN” or “REJECT” as a classification result of the classification model.

Furthermore, if input data is discriminated as ID data, the classification model has been trained so that a node corresponding to any one of a plurality of classes is activated. Accordingly, a processor may classify input data as a class corresponding to the corresponding input data if the node of a specific class is activated.

Hereinafter, in this disclosure, an implementation example using a classification model applied to an embodiment of the present disclosure is described.

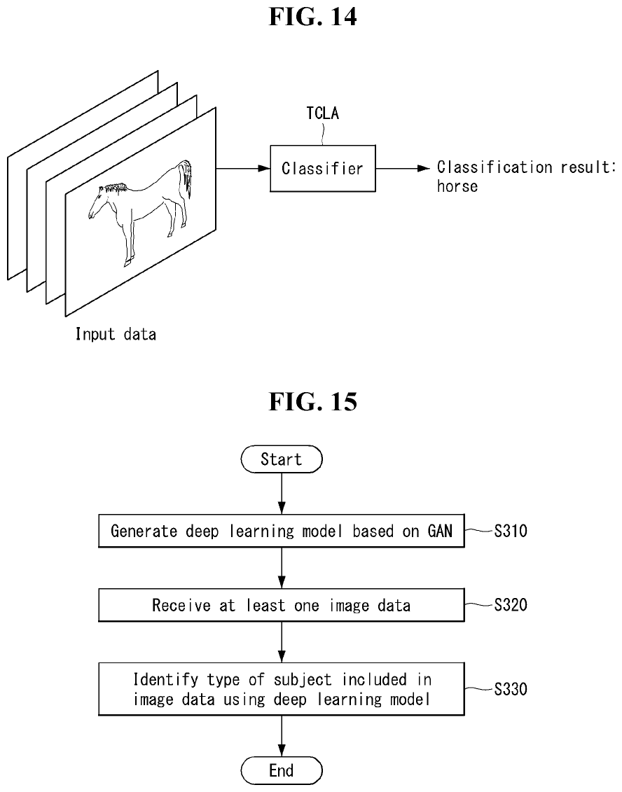

FIGS. 14 and 15 are diagrams for describing one implementation example and implementation method of data classification using a trained artificial neural network model according to an embodiment of the present disclosure.

First Implementation Example: Image Detection

In general, the AI apparatus 20 may be used for image detection. However, if a classification model (TCLA) based on an artificial neural network (ANN) having a softmax layer is used, there is a problem in that it is difficult to derive a result of “UNKNOWN” or “REJECTION.”

If the classification model (TCLA) based on a GAN according to an embodiment of the present disclosure is used, a result of “UNKNOWN” or “REJECTION” may be derived using simulated data generated through a generative model in addition to pre-learnt data.

Specifically, the AI apparatus 20 may generate an image corresponding to a specific class by applying class information to the generative model. In this case, the generated image is a virtual image, and may be an image having a similarity different from that of real data depending on a level of the simulation function of the generative model.

The AI apparatus 20 may train the classification model (TCLA) by applying the generated image and real image to the classification model (TCLA). In this case, the generative model and the classification model (TCLA) may be trained through hostile training based on a GAN.

As a result, a classification model (TCLA) generated using a method of training a classification model (TCLA) based on a GAN according to an embodiment of the present disclosure may configure a training dataset by additionally including a dataset generated by a generative model in addition to a dataset preset by a user.

When an image included in the OD data generated during the first period described in the inference step is input, the AI apparatus 20 may determine an inference result of “UNKNOWN” or “REJECTION.” Furthermore, when an image included in the ID data generated during the second period described above is input, the AI apparatus 20 may detect the type of an object included in the input image.

Referring to FIG. 14, the classification model (TCLA) may train a horse image, that is, real data, and class information “horse” corresponding to the horse image. In this case, the AI apparatus 20 may generate a plurality of virtual images that simulate the horse by applying the class information “horse” to a generative model using the generative model. The plurality of virtual images may include a zebra, a donkey and a camel similar to the horse.

The horse may be included in ID data. The zebra, the donkey and the camel may be included in OD data.

When an image of a horse is input to the trained classification model (TCLA), the classification model (TCLA) of the AI apparatus 20 may infer a horse as a classification result. In contrast, when an image of a donkey, zebra or camel is input to the trained classification model (TCLA), the AI apparatus 20 may infer “UNKNOWN” with respect to the classification model (TCLA).

As described above, if the classification model (TCLA) based on a GAN according to an embodiment of the present disclosure is used, when OD data other than a real image pre-trained by a user, that is, an ID data range, is applied to the classification model (TCLA), “UNKNOWN” may be inferred. Furthermore, simulated data having a high similarity with the ID data is generated during a second period, and can be configured as a training dataset. Accordingly, the accuracy of a classification result can be improved because the ID data range is extended.

Referring to FIG. 15, the AI apparatus 20 may generate a deep learning model based on a GAN (S310).

The AI apparatus 20 may receive at least one image data (S320).

The AI apparatus 20 may identify the type of subject included in the image data using the deep learning model (S330).

Second Implementation Example: Query Rejection for Voice Recognition

As described above, if the classification model based on a GAN according to an embodiment of the present disclosure is used, the AI apparatus 20 may generate OD data and train the classification model. The trained classification model may derive an inference result of “UNKNOWN” or “REJECTION” if the OD data is applied.

If this is applied to a voice recognition device, the same effects as those of the aforementioned image detection can be implemented.

For example, the AI apparatus 20 can reduce the probability that an erroneous control operation may be performed on OD data that has never been labeled based on an erroneous voice recognition result, and may enable an extended voice recognition function to be performed on data that has not been pre-trained by a user equipment by extending ID data through a generative model.

The present disclosure may be implemented as a computer-readable code in a medium in which a program is written. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, magnetic tapes, floppy disks, and optical data storages, and also include that the computer-readable medium is implemented in the form of carrier waves (e.g., transmission through the Internet). Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

What is claimed is:

1. A method of training a classification model based on a generative adversarial network (GAN), the method comprising:
receiving real data;
receiving first simulated data generated by a generative model during a first period and training a GAN model using the first simulated data and the real data during the first period; and
receiving second simulated data generated by the generative model during a second period after a lapse of the first period and training the GAN model using the second simulated data and the real data during the second period,
wherein the GAN model includes the generative model for generating the first and second simulated data and a classification model for discriminating between the real data and the first and second simulated data.

2. The method of claim 1,
wherein the real data is training data provided by a user.

3. The method of claim 1,
wherein the second simulated data has a higher similarity with the real data than the first simulated data.

4. The method of claim 3,
wherein the similarity is similarity based on an angle between a vector corresponding to the first or second simulated data and a vector of the real data.

5. The method of claim 3,
wherein the similarity is determined by comparing probability distributions of the first or second simulated data and the real data using a Kullback Leibler term (KL term).

6. The method of claim 1,
wherein a length of the first period and the second period is ½ times a total training period.

7. The method of claim 1,
wherein a label value of all nodes included in an output layer of the classification model during the first period is 1/N, where N is a number of all the nodes included in the output layer.

8. The method of claim 1,
wherein a label of all nodes included in an output layer of the classification model during the second period is stored as a one-hot vector.

9. The method of claim 1,
wherein the GAN model outputs unknown when all nodes included in an output layer of the classification model are deactivated.

10. The method of claim 1,
wherein the GAN model is trained in a backward propagation manner.

11. The method of claim 1,
wherein the classification model includes:
a first classification model for discriminating between the first or second simulated data and the real data, and
a second classification model for discriminating between one or more discrimination targets by comparing scores or probability distributions corresponding to classes of the one or more discrimination target, respectively.

12. The method of claim 11,
wherein training the GAN model during the first period includes:
determining a first error for the first simulated data by inputting, to the first classification model, the first simulated data generated by the generative model;
determining a second error for the first simulated data by inputting the first simulated data to the second classification model; and
training at least one of the generative model or the first and second classification models using the first and second errors.

13. The method of claim 11,
wherein training the GAN model during the second period includes:
determining a third error for the first simulated data by inputting, to the first classification model, the second simulated data generated by the generative model;
determining a fourth error for the first simulated data by inputting the second simulated data to the second classification model; and
training at least one of the generative model, or the first and second classification models using the third and fourth errors.

14. An intelligent device comprising:
a communication module configured to receive real data;
a processor configured to receive first simulated data generated by a generative model during a first period, train a GAN model using the first simulated data and the real data during the first period, receive second simulated data generated by the generative model during a second period after a lapse of the first period, and train the GAN model using the second simulated data and the real data during the second period,
wherein the GAN model includes the generative model for generating the first and second simulated data and a classification model for discriminating between the real data and the first and second simulated data.

15. The intelligent device of claim 14,
wherein the real data is training data pre-configured by a user.

16. The intelligent device of claim 14,
wherein the second simulated data has a higher similarity with the real data than the first simulated data.

17. The intelligent device of claim 16,
wherein the similarity is similarity based on an angle between a vector corresponding to the first or second simulated data and a vector of the real data.

18. The intelligent device of claim 16,
wherein the similarity is determined by comparing probability distributions of the first or second simulated data and the real data using a Kullback Leibler term (KL term).

19. The intelligent device of claim 14,
wherein a length of the first period and the second period is ½ times a total training period.

20. The intelligent device of claim 14,
wherein a label value of all nodes included in an output layer of the classification model during the first period is 1/N, where N is a number of all the nodes included in the output layer.
